(19) United States
(12) Patent Application Publication
(10) Pub. No.: US 2025/0130757 A1
(43) Pub. Date: Apr. 24, 2025

(54) MODIFYING AUDIO INPUTS TO PROVIDE REALISTIC AUDIO OUTPUTS IN AN EXTENDED-REALITY ENVIRONMENT, AND SYSTEMS AND METHODS OF USE THEREOF

(71) Applicant: Meta Platforms Technologies, LLC, Menlo Park, CA (US)

(72) Inventor: Pablo Francisco Faundez Hoffmann, Kenmore, WA (US)

(21) Appl. No.: 18/824,822

(22) Filed: Sep. 4, 2024

Related U.S. Application Data
(60) Provisional application No. 63/592,131, filed on Oct. 20, 2023.
(60) Provisional application No. 63/651,262, filed on May 23, 2024.

(51) Int. Cl. G06F 3/16; G02B 27/01; G06T 19/00

(52) U.S. Cl. CPC G06F 3/16; G02B 27/017; G06T 19/006

(57) ABSTRACT

An example method of matching audio inputs to an extended-reality environment, comprises, receiving an audio input from a microphone at a head-worn extended-reality device, and the audio input occurs at a simulated location in a simulated environment. The method also includes, processing the audio input into processed audio by changing the audio based on simulated objects within the simulated environment. The processed audio is configured to be perceived in a manner as if the audio input is being altered by the simulated environment. The example method includes transmitting the processed audio to the device for playback, such that the audio is perceived as being spoken in the simulated environment.

### RELATED APPLICATIONS

This claims benefit of, and the priority to, U.S. Provisional Application Ser. No. 63/592,131, entitled “Modifying Audio Inputs to Provide Realistic Audio Outputs In An Extended-Reality Environment, And Systems And Methods of Use Thereof” filed Oct. 20, 2023, and U.S. Provisional Application Ser. No. 63/651,262, entitled “Modifying Audio Inputs to Provide Realistic Audio Outputs In An Extended-Reality Environment, And Systems And Methods of Use Thereof” filed May 23, 2024, the disclosure of which are each incorporated in their respective entireties by this reference.

### TECHNICAL FIELD

This relates generally to modifying audio inputs received at a head-worn extended-reality device to create simulated audio outputs based on a simulated environment such that the wearer of the head-worn extended-reality device in the simulated environment perceives their audio outputs as being reflected and reverberated in the simulated environment in a manner similar to how one perceives their own voice in a non-simulated environment.

### BACKGROUND

Extended-reality environments are just as immersive as their least immersive aspect. While many extended-reality environments take into account improving visual aspects to improve the user experience. However, many extended realities neglect the audio aspects of the extended reality environment, which detracts from the immersive experience.

As such, there is a need to address one or more of the above-identified challenges. A brief summary of solutions to the issues noted above are described below.

### SUMMARY

An example method of matching audio inputs to an extended-reality environment is described below, which seeks to improve the immersion of an extended-reality environment. The example method comprises, receiving an audio input at a head-worn extended-reality device (e.g., FIG. 1 at block 102), wherein the audio input occurs at a simulated location in a simulated environment (e.g., measured or simulated near field transfer functions (e.g., Near Field (NF) Impulse Response (IR)) which could, for example, be the acoustic transmission between the mouth of a user of the head-worn extended-reality device and the microphone(s) in head-worn extended-reality device, such as a microphone array integrated in smart glasses, AR glasses, and VR headsets). For example, block 106 in FIG. 1 represents a room acoustic simulation. The method also includes producing a direct path impulse response (IR) and a reflected room impulse response (RIR) (e.g., RIR including at least effects of specular reflections, diffraction, and reverberation) based on a directionality of an audio source (e.g., a functional model of the directivity/directionality of a human voice which in one embodiment can be represented by a frequency dependent weighted combination of a monopole source and dipole source) at a simulated location in a simulated environment (e.g., a room acoustic simulation that generates a RIR at the source location assuming a single-channel omnidirectional receiver); In some embodiments, a time instant that divides the direct path and the reflected path may be estimated using the distance between the source and the closest reflective surface. For example, FIG. 1 shows blocks 108 and 110 representing that a direct oath IR and reflected RIRs are produced. The method also includes, cross-correlating the direct path IR with the audio (e.g., the NF IR) to identify a time misalignment; In some embodiments, the misalignment is a non-existent and other embodiments a misalignment exists; For example, block 112 in FIG. 1. The method also includes, time aligning the reflected RIR with the audio (e.g., the NF IR) based on the time misalignment to produce time-aligned reflected RIR; For example, FIG. 1 shows an example time alignment in block 114. The method also includes, decomposing the time-aligned RIR and the audio input (e.g., including far field IRs) to produce high-order ambisonics (HoA). For example, FIG. 1 shows an example ambisonic decomposition in block 116. In some embodiments, the decomposing also includes decomposing measure or simulated FF IRs. The method also includes, generating a hybrid RIR based on the HoA, wherein the hybrid RIR includes only reflected HoA components (e.g., only reflected HoA components from the wearers voice). The method also includes, rendering multichannel audio in an ambisonic domain based on the hybrid RIR (e.g., hybrid device related RIRs to render multichannel audio in the ambisonic domain and transform that to the time domain); For example, FIG. 1 illustrates ambisonic rendering in block 120. The method also includes, concatenating the multichannel audio and the received audio to produce a concatenated audio transmission corresponding to a simulated extended reality environment (e.g., concatenate the measured/simulated NF IRs with the reflected RIRs to generate a fully hybrid NF/FF device-related RIRs). For example, FIG. 1 illustrates concatenating in block 122. The method also includes outputting the concatenated audio transmission at the head-worn extended-reality device.

The features and advantages described in the specification are not necessarily all inclusive and, in particular, certain additional features and advantages will be apparent to one of ordinary skill in the art in view of the drawings, specification, and claims. Moreover, it should be noted that the language used in the specification has been principally selected for readability and instructional purposes.

Having summarized the above example aspects, a brief description of the drawings will now be presented.

### BRIEF DESCRIPTION OF THE DRAWINGS

For a better understanding of the various described embodiments, reference should be made to the Detailed Description below, in conjunction with the following drawings in which like reference numerals refer to corresponding parts throughout the figures.

FIG. 1 illustrates a method flow chart for hybrid near-field impulse responses (IR)s and far-field (FF) high-order-ambisonic (HoA) encoding for the generation of a head-worn extended-reality device microphone-array near-field (NF) transfer functions including room acoustic, in accordance with some embodiments.

FIGS. 2A, 2B, 2C-1, 2C-2, 2D-1, and 2D-2 illustrate example artificial-reality systems, in accordance with some embodiments.

FIGS. 3A, 3B-1, 3B-2, and 3C illustrate example head-wearable devices, in accordance with some embodiments.

FIG. 4 illustrates a functional model of the directivity of human voice, in accordance with some embodiments.

FIG. 5 illustrates a high-order ambisonics decomposition, in accordance with some embodiments.

In accordance with common practice, the various features illustrated in the drawings may not be drawn to scale. Accordingly, the dimensions of the various features may be arbitrarily expanded or reduced for clarity. In addition, some of the drawings may not depict all of the components of a given system, method, or device. Finally, like reference numerals may be used to denote like features throughout the specification and figures.

### DETAILED DESCRIPTION

Numerous details are described herein to provide a thorough understanding of the example embodiments illustrated in the accompanying drawings. However, some embodiments may be practiced without many of the specific details, and the scope of the claims is only limited by those features and aspects specifically recited in the claims. Furthermore, well-known processes, components, and materials have not necessarily been described in exhaustive detail so as to avoid obscuring pertinent aspects of the embodiments described herein.

Embodiments of this disclosure can include or be implemented in conjunction with various types or embodiments of artificial-reality systems. Artificial-reality (AR), as described herein, is any superimposed functionality and or sensory-detectable presentation provided by an artificial-reality system within a user's physical surroundings. Such artificial-realities can include and/or represent virtual reality (VR), augmented reality, mixed artificial-reality (MAR), or some combination and/or variation one of these. For example, a user can perform a swiping in-air hand gesture to cause a song to be skipped by a song-providing API providing playback at, for example, a home speaker. An AR environment, as described herein, includes, but is not limited to, VR environments (including non-immersive, semi-immersive, and fully immersive VR environments); augmented-reality environments (including marker-based augmented-reality environments, markerless augmented-reality environments, location-based augmented-reality environments, and projection-based augmented-reality environments); hybrid reality; and other types of mixed-reality environments.

Artificial-reality content can include completely generated content or generated content combined with captured (e.g., real-world) content. The artificial-reality content can include video, audio, haptic events, or some combination thereof, any of which can be presented in a single channel or in multiple channels (such as stereo video that produces a three-dimensional effect to a viewer). Additionally, in some embodiments, artificial reality can also be associated with applications, products, accessories, services, or some combination thereof, which are used, for example, to create content in an artificial reality and/or are otherwise used in (e.g., to perform activities in) an artificial reality.

A hand gesture, as described herein, can include an in-air gesture, a surface-contact gesture, and or other gestures that can be detected and determined based on movements of a single hand (e.g., a one-handed gesture performed with a user's hand that is detected by one or more sensors of a wearable device (e.g., electromyography (EMG) and/or inertial measurement units (IMU)s of a wrist-wearable device) and/or detected via image data captured by an imaging device of a wearable device (e.g., a camera of a head-wearable device)) or a combination of the user's hands. In-air means, in some embodiments, that the user hand does not contact a surface, object, or portion of an electronic device (e.g., a head-wearable device or other communicatively coupled device, such as the wrist-wearable device), in other words the gesture is performed in open air in 3D space and without contacting a surface, an object, or an electronic device. Surface-contact gestures (contacts at a surface, object, body part of the user, or electronic device) more generally are also contemplated in which a contact (or an intention to contact) is detected at a surface (e.g., a single or double finger tap on a table, on a user's hand or another finger, on the user's leg, a couch, a steering wheel, etc.). The different hand gestures disclosed herein can be detected using image data and/or sensor data (e.g., neuromuscular signals sensed by one or more biopotential sensors (e.g., EMG sensors) or other types of data from other sensors, such as proximity sensors, time-of-flight (ToF) sensors, sensors of an inertial measurement unit, etc.) detected by a wearable device worn by the user and/or other electronic devices in the user's possession (e.g., smartphones, laptops, imaging devices, intermediary devices, and/or other devices described herein).

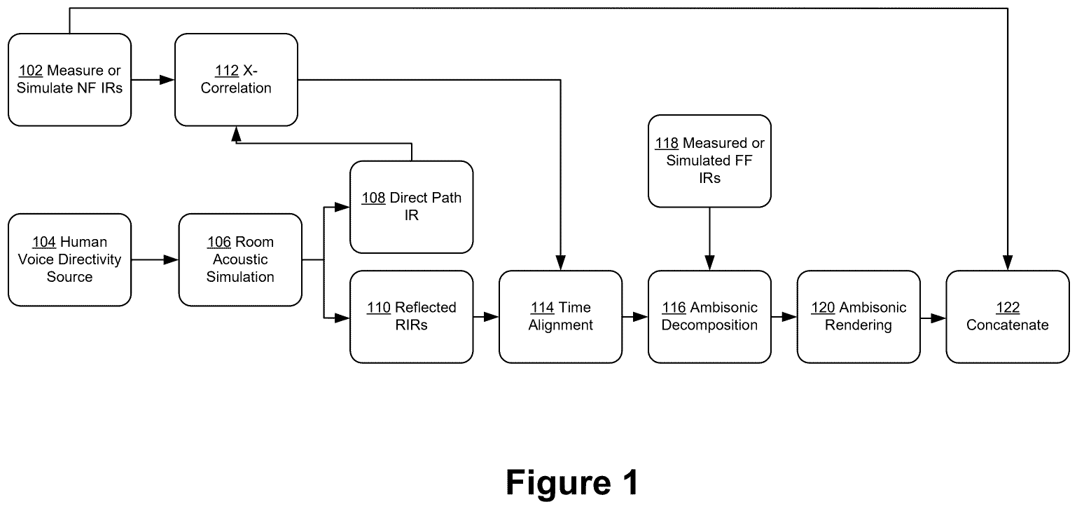

FIG. 1 illustrates a method flow chart for hybrid near-field impulse responses (IR)s and far-field (FF) high-order-ambisonic (HoA) encoding for the generation of a head-worn extended-reality device microphone-array near-field (NF) transfer functions including room acoustic, in accordance with some embodiments. As will be described, the flow chart generally illustrates an algorithm for the hybrid combination of near field acoustic transmission to represent the direct acoustic path in a device-related room impulse response such as the mouth to mic-array response for a head-worn extended-reality device (e.g., smart glasses, augmented reality glasses, or headsets), and the far-field reflected acoustic transmission to represent the effect of room acoustics on the near field source.

Block 102 represents either measured or simulated near field transfer functions which could, for example, be the acoustic transmission between the mouth of a user and the microphone(s) in a head-worn extended-reality device microphone array.

Block 104 represents a functional model of the directivity of a human voice which in one embodiment may be represented by a frequency dependent weighted combination of a monopole source and dipole source.

Block 106 represents simulating a room acoustic simulation to generate a reflected room impulse response (RIR) at the source location when using a single-channel omnidirectional receiver.

Block 108 represents the direct path of the RIR generated by the simulation that occurs in block 106. Block 110 represents the reflected path of the RIR generated by the simulation. In some embodiments, the reflected path includes one or more effects of specular reflections, diffraction, and reverberation. In some embodiments, the time instant that divides the direct path and the reflected path may be estimated using the distance between the source and the closest reflective surface.

Block 112 shows that a cross-correlation function is computed between the direct path IRs shown in block 106 and the NF IRs shown in block 102 to identify any time misalignment between the two responses.

Block 114 illustrates that the output of block 110 is used to time-align the reflected RIR generated in block 106 with the NF IRs from block 102.

Block 116 shows that time-aligned reflected RIR and Measured/Simulated FF IRs (from block 118) are decomposed into high-order ambisonics to generate a hybrid device-related RIRs that represents only the reflected HoA components from a wearer of the head-worn extended-reality device's voice.

Block 120 illustrates that hybrid device-related RIRs are used to render multichannel audio in the ambisonic domain and transform that to the time domain. Block 122 shows that the measure/simulated NF IRs are concatenated with the reflected RIRs to generate the fully hybrid NF/FF device-related RIRs.

(A1) In accordance with some embodiments, a method of matching audio inputs to an extended-reality environment, comprises, receiving an audio input at a head-worn extended-reality device (e.g., measured or simulated near field transfer functions which could, for example, be the acoustic transmission between the mouth of a user of the head-worn extended-reality device and the microphone(s) in head-worn extended-reality device, such as a microphone array integrated in smart glasses, AR glasses, and VR headsets). In some embodiments, the audio input occurs at a simulated location in a simulated environment. See, FIG. 1 at block 102. The method includes, processing the audio input into processed audio by changing the audio based on simulated objects within the simulated environment. The processed audio is configured to be perceived in a manner as if the audio input is being altered by the simulated environment. The method also includes, transmitting the processed audio to the device for playback, such that the audio is perceived as being spoken in the simulated environment. See block 104, block 106, and block 122 as an example in FIG. 1.

(A2) In some embodiments of A1, processing the audio includes, producing a direct path impulse response (IR) and a reflected room impulse response (RIR) based on a directionality of an audio source at the simulated location in the simulated environment. See blocks 106, 108 and 110 in FIG. 1 as an example.

(A3) In some embodiments of A2, wherein processing the audio includes, cross-correlating the direct path IR with the audio to identify a time misalignment (e.g., time misalignment can be zero). For example, block 112 in FIG. 1 as an example.

(A4) In some embodiments, of A3, processing the audio includes, time aligning the reflected RIR with the audio based on the time misalignment to produce time-aligned reflected RIR. For example, FIG. 1 shows an example time alignment in block 114.

(A5) In some embodiments of A4, processing the audio includes, decomposing the time-aligned RIR and the audio input to produce high-order ambisonics (HoA). For example, FIG. 1 shows an example ambisonic decomposition in block 116. In some embodiments, the decomposing also includes decomposing measure or simulated FF IRs.

(A6) In some embodiments of A5, processing the audio includes, generating a hybrid RIR based on the HoA, and the hybrid RIR includes only reflected HoA components. FIG. 1 shows an example ambisonic decomposition in block 116.

(A7) In some embodiments of A6 processing the audio includes, rendering multichannel audio in an ambisonic domain based on the hybrid RIR. For example, FIG. 1 illustrates ambisonic rendering in block 120.

(A8) In some embodiments of A7, processing the audio includes, concatenating the multichannel audio and the received audio to produce a concatenated audio transmission corresponding to a simulated extended reality environment. For example, FIG. 1 illustrates concatenating in block 122 as an example.

(A9) In some embodiments of any one of A1-A8, the method includes receiving the audio input from the microphone at a head-worn extended-reality device worn by a user, wherein (i) the audio input is received while the user is at another location in the simulated environment and (ii) the audio input includes the representation of the user's voice. The method also includes, processing the audio input into another processed audio by changing the audio input based on the simulated objects within the simulated environment, wherein the processed audio is configured to be perceived by the user in a manner as if the audio input is being altered by the simulated environment. The method also requires transmitting the other processed audio to the head-worn extended-reality device for playback, such that the other processed audio is perceived as being spoken by the user in the simulated environment at the other location.

(A9) In some embodiments of A9, the simulated environment includes a plurality of simulated objects that each have different acoustical properties, wherein the acoustical properties are defined by one or more of a simulated shape, a simulated material, and a simulated distance from the user in the simulated environment.

(B1) In accordance with some embodiments, a method of matching audio inputs to an extended-reality environment, comprises, receiving an audio input at a head-worn extended-reality device (e.g., FIG. 1 at block 102), wherein the audio input occurs at a simulated location in a simulated environment (e.g., measured or simulated near field transfer functions (e.g., Near Field (NF) Impulse Response (IR)) which could, for example, be the acoustic transmission between the mouth of a user of the head-worn extended-reality device and the microphone(s) in head-worn extended-reality device, such as a microphone array integrated in smart glasses, AR glasses, and VR headsets). For example, block 106 in FIG. 1 represents a room acoustic simulation. The method also includes producing a direct path impulse response (IR) and a reflected room impulse response (RIR) (e.g., RIR including at least effects of specular reflections, diffraction, and reverberation) based on a directionality of an audio source (e.g., a functional model of the directivity/directionality of a human voice which in one embodiment can be represented by a frequency dependent weighted combination of a monopole source and dipole source) at a simulated location in a simulated environment (e.g., a room acoustic simulation that generates a RIR at the source location assuming a single-channel omnidirectional receiver); In some embodiments, a time instant that divides the direct path and the reflected path may be estimated using the distance between the source and the closest reflective surface. For example, FIG. 1 shows blocks 108 and 110 representing that a direct oath IR and reflected RIRs are produced. The method also includes, cross-correlating the direct path IR with the audio (e.g., the NF IR) to identify a time misalignment; In some embodiments, the misalignment is a non-existent and other embodiments a misalignment exists; For example, block 112 in FIG. 1. The method also includes, time aligning the reflected RIR with the audio (e.g., the NF IR) based on the time misalignment to produce time-aligned reflected RIR; For example, FIG. 1 shows an example time alignment in block 114. The method also includes, decomposing the time-aligned RIR and the audio input (e.g., including far field IRs) to produce high-order ambisonics (HoA). For example, FIG. 1 shows an example ambisonic decomposition in block 116. In some embodiments, the decomposing also includes decomposing measure or simulated FF IRs. The method also includes, generating a hybrid RIR based on the HoA, wherein the hybrid RIR includes only reflected HoA components (e.g., only reflected HoA components from the wearers voice). The method also includes, rendering multichannel audio in an ambisonic domain based on the hybrid RIR (e.g., hybrid device related RIRs to render multichannel audio in the ambisonic domain and transform that to the time domain); For example, FIG. 1 illustrates ambisonic rendering in block 120. The method also includes, concatenating the multichannel audio and the received audio to produce a concatenated audio transmission corresponding to a simulated extended reality environment (e.g., concatenate the measured/simulated NF IRs with the reflected RIRs to generate a fully hybrid NF/FF device-related RIRs). For example, FIG. 1 illustrates concatenating in block 122.

(C1) In accordance with some embodiments, a head-worn extended-reality device (e.g., an augmented reality headset, a virtual reality headset, etc.) is configured in accordance with any one of A1-A9.

(D1) In accordance with some embodiments, a system for interacting within an artificial reality, includes: a head-worn extended-reality device and another head-worn extended-reality device, where the head-worn extended-reality device and the other head-worn extended-reality device are configured in accordance with any one of A1-A9.

(E1) In accordance with some embodiments, a non-transitory computer-readable storage medium comprises instructions, that when executed by a head-worn extended-reality system (or a head-worn extended-reality device), cause the head-worn extended-reality system (device) to cause or cause performance of any one of A1-A9.

The devices described above are further detailed below, including systems, wrist-wearable devices, headset devices, and smart textile-based garments. Specific operations described above may occur as a result of specific hardware, such hardware is described in further detail below. The devices described below are not limiting and features on these devices can be removed or additional features can be added to these devices. The different devices can include one or more analogous hardware components. For brevity, analogous devices and components are described below. Any differences in the devices and components are described below in their respective sections.

As described herein, a processor (e.g., a central processing unit (CPU) or microcontroller unit (MCU)), is an electronic component that is responsible for executing instructions and controlling the operation of an electronic device (e.g., a wrist-wearable device 201, a head-wearable device, an HIPD 205, a smart textile-based garment 209, or other computer system). There are various types of processors that may be used interchangeably or specifically required by embodiments described herein. For example, a processor may be (i) a general processor designed to perform a wide range of tasks, such as running software applications, managing operating systems, and performing arithmetic and logical operations; (ii) a microcontroller designed for specific tasks such as controlling electronic devices, sensors, and motors; (iii) a graphics processing unit (GPU) designed to accelerate the creation and rendering of images, videos, and animations (e.g., virtual-reality animations, such as three-dimensional modeling); (iv) a field-programmable gate array (FPGA) that can be programmed and reconfigured after manufacturing and/or customized to perform specific tasks, such as signal processing, cryptography, and machine learning; (v) a digital signal processor (DSP) designed to perform mathematical operations on signals such as audio, video, and radio waves. One of skill in the art will understand that one or more processors of one or more electronic devices may be used in various embodiments described herein.

As described herein, controllers are electronic components that manage and coordinate the operation of other components within an electronic device (e.g., controlling inputs, processing data, and/or generating outputs). Examples of controllers can include (i) microcontrollers, including small, low-power controllers that are commonly used in embedded systems and Internet of Things (IoT) devices; (ii) programmable logic controllers (PLCs) that may be configured to be used in industrial automation systems to control and monitor manufacturing processes; (iii) system-on-a-chip (SoC) controllers that integrate multiple components such as processors, memory, I/O interfaces, and other peripherals into a single chip; and/or DSPs. As described herein, a graphics module is a component or software module that is designed to handle graphical operations and/or processes, and can include a hardware module and/or a software module.

As described herein, memory refers to electronic components in a computer or electronic device that store data and instructions for the processor to access and manipulate. The devices described herein can include volatile and non-volatile memory. Examples of memory can include (i) random access memory (RAM), such as DRAM, SRAM, DDR RAM or other random access solid state memory devices, configured to store data and instructions temporarily; (ii) read-only memory (ROM) configured to store data and instructions permanently (e.g., one or more portions of system firmware and/or boot loaders); (iii) flash memory, magnetic disk storage devices, optical disk storage devices, other non-volatile solid state storage devices, which can be configured to store data in electronic devices (e.g., universal serial bus (USB) drives, memory cards, and/or solid-state drives (SSDs)); and (iv) cache memory configured to temporarily store frequently accessed data and instructions. Memory, as described herein, can include structured data (e.g., SQL databases, MongoDB databases, GraphQL data, or JSON data). Other examples of memory can include: (i) profile data, including user account data, user settings, and/or other user data stored by the user; (ii) sensor data detected and/or otherwise obtained by one or more sensors; (iii) media content data including stored image data, audio data, documents, and the like; (iv) application data, which can include data collected and/or otherwise obtained and stored during use of an application; and/or any other types of data described herein.

As described herein, a power system of an electronic device is configured to convert incoming electrical power into a form that can be used to operate the device. A power system can include various components, including (i) a power source, which can be an alternating current (AC) adapter or a direct current (DC) adapter power supply; (ii) a charger input that can be configured to use a wired and/or wireless connection (which may be part of a peripheral interface, such as a USB, micro-USB interface, near-field magnetic coupling, magnetic inductive and magnetic resonance charging, and/or radio frequency (RF) charging); (iii) a power-management integrated circuit, configured to distribute power to various components of the device and ensure that the device operates within safe limits (e.g., regulating voltage, controlling current flow, and/or managing heat dissipation); and/or (iv) a battery configured to store power to provide usable power to components of one or more electronic devices.

As described herein, peripheral interfaces are electronic components (e.g., of electronic devices) that allow electronic devices to communicate with other devices or peripherals and can provide a means for input and output of data and signals. Examples of peripheral interfaces can include (i) USB and/or micro-USB interfaces configured for connecting devices to an electronic device; (ii) Bluetooth interfaces configured to allow devices to communicate with each other, including Bluetooth low energy (BLE); (iii) near-field communication (NFC) interfaces configured to be short-range wireless interfaces for operations such as access control; (iv) POGO pins, which may be small, spring-loaded pins configured to provide a charging interface; (v) wireless charging interfaces; (vi) global-position system (GPS) interfaces; (vii) Wi-Fi interfaces for providing a connection between a device and a wireless network; and (viii) sensor interfaces.

As described herein, sensors are electronic components (e.g., in and/or otherwise in electronic communication with electronic devices, such as wearable devices) configured to detect physical and environmental changes and generate electrical signals. Examples of sensors can include (i) imaging sensors for collecting imaging data (e.g., including one or more cameras disposed on a respective electronic device); (ii) biopotential-signal sensors; (iii) inertial measurement unit (e.g., IMUs) for detecting, for example, angular rate, force, magnetic field, and/or changes in acceleration; (iv) heart rate sensors for measuring a user's heart rate; (v) SpO2 sensors for measuring blood oxygen saturation and/or other biometric data of a user; (vi) capacitive sensors for detecting changes in potential at a portion of a user's body (e.g., a sensor-skin interface) and/or the proximity of other devices or objects; and (vii) light sensors (e.g., ToF sensors, infrared light sensors, or visible light sensors), and/or sensors for sensing data from the user or the user's environment. As described herein biopotential-signal-sensing components are devices used to measure electrical activity within the body (e.g., biopotential-signal sensors). Some types of biopotential-signal sensors include: (i) electroencephalography (EEG) sensors configured to measure electrical activity in the brain to diagnose neurological disorders; (ii) electrocardiography (ECG or EKG) sensors configured to measure electrical activity of the heart to diagnose heart problems; (iii) electromyography (EMG) sensors configured to measure the electrical activity of muscles and diagnose neuromuscular disorders; (iv) electrooculography (EOG) sensors configured to measure the electrical activity of eye muscles to detect eye movement and diagnose eye disorders.

As described herein, an application stored in memory of an electronic device (e.g., software) includes instructions stored in the memory. Examples of such applications include (i) games; (ii) word processors; (iii) messaging applications; (iv) media-streaming applications; (v) financial applications; (vi) calendars; (vii) clocks; (viii) web browsers; (ix) social media applications, (x) camera applications, (xi) web-based applications; (xii) health applications; (xiii) artificial-reality (AR) applications, and/or any other applications that can be stored in memory. The applications can operate in conjunction with data and/or one or more components of a device or communicatively coupled devices to perform one or more operations and/or functions.

As described herein, communication interface modules can include hardware and/or software capable of data communications using any of a variety of custom or standard wireless protocols (e.g., IEEE 802.15.4, Wi-Fi, ZigBee, 6LoWPAN, Thread, Z-Wave, Bluetooth Smart, ISA100.11a, WirelessHART, or MiWi), custom or standard wired protocols (e.g., Ethernet or HomePlug), and/or any other suitable communication protocol, including communication protocols not yet developed as of the filing date of this document. A communication interface is a mechanism that enables different systems or devices to exchange information and data with each other, including hardware, software, or a combination of both hardware and software. For example, a communication interface can refer to a physical connector and/or port on a device that enables communication with other devices (e.g., USB, Ethernet, HDMI, or Bluetooth). In some embodiments, a communication interface can refer to a software layer that enables different software programs to communicate with each other (e.g., application programming interfaces (APIs) and protocols such as HTTP and TCP/IP).

As described herein, a graphics module is a component or software module that is designed to handle graphical operations and/or processes, and can include a hardware module and/or a software module.

As described herein, non-transitory computer-readable storage media are physical devices or storage medium that can be used to store electronic data in a non-transitory form (e.g., such that the data is stored permanently until it is intentionally deleted or modified).

### Example AR Systems

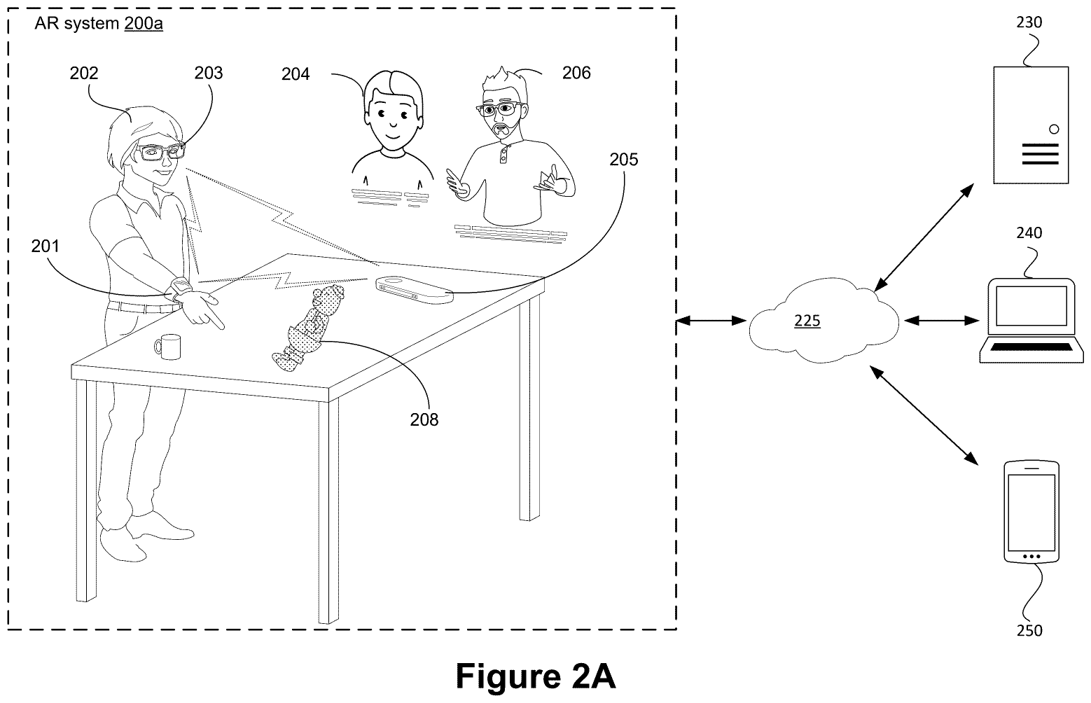

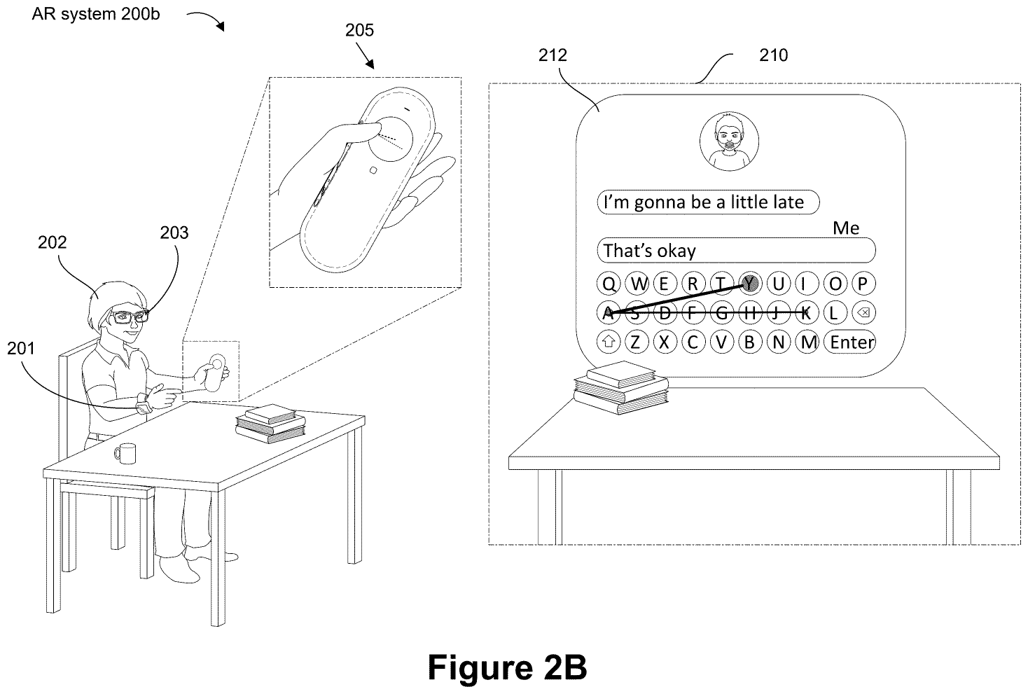

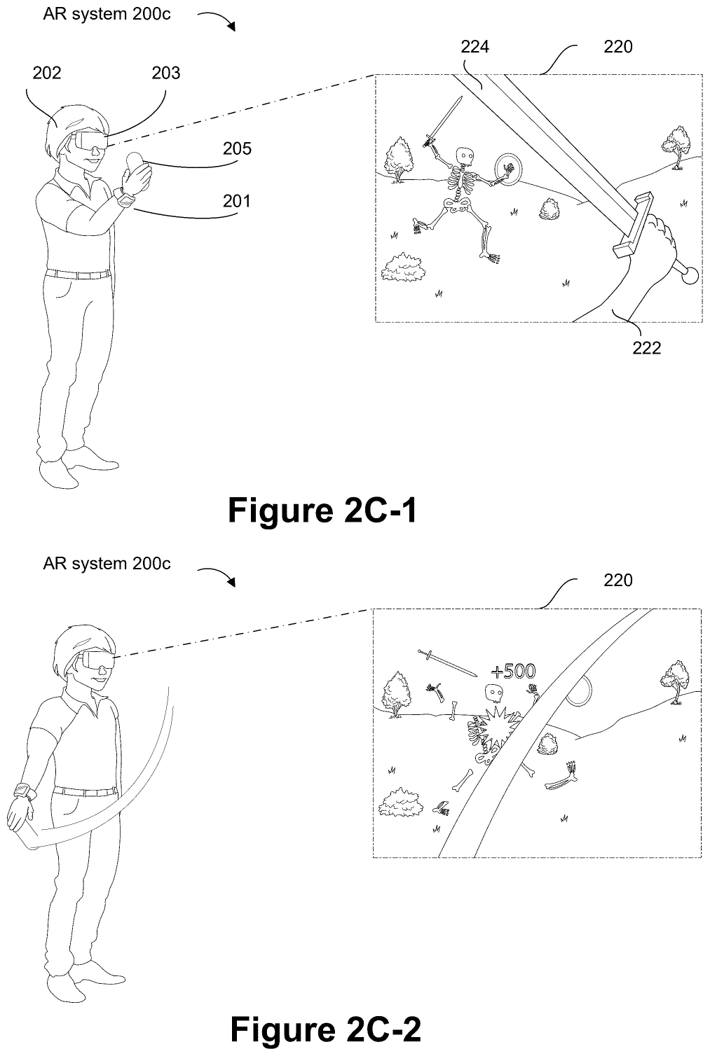

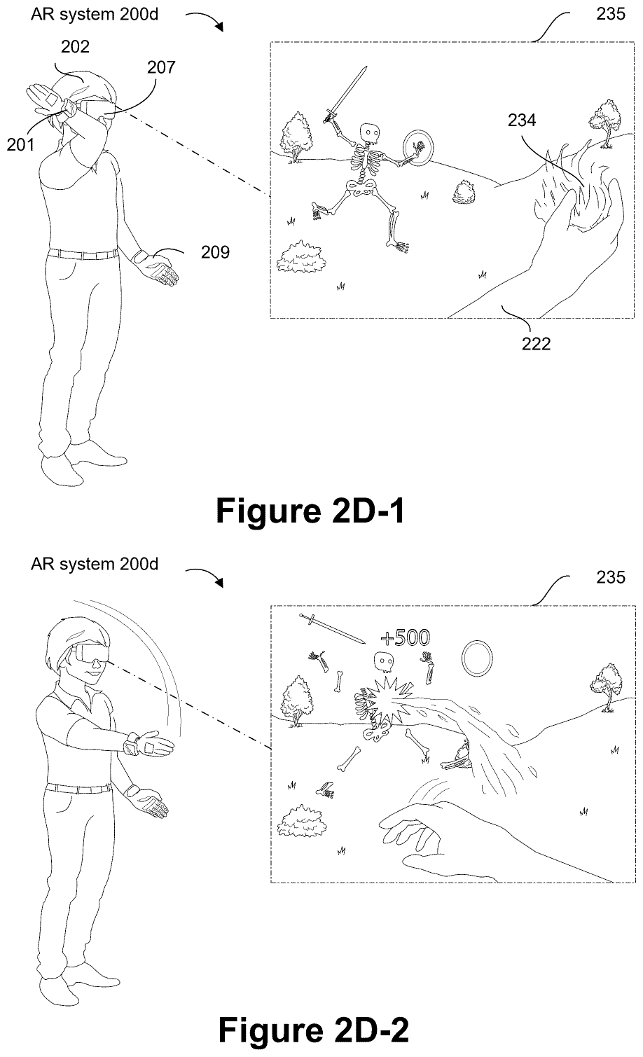

FIGS. 2A, 2B, 2C-1, 2C-2, 2D-1, and 2D-2 illustrate example AR systems, in accordance with some embodiments. FIG. 2A shows a first AR system 200a and first example user interactions using a wrist-wearable device 201, a head-wearable device (e.g., AR device 203), and/or a handheld intermediary processing device (HIPD) 205. FIG. 2B shows a second AR system 200b and second example user interactions using a wrist-wearable device 201, AR device 203, and/or an HIPD 205. FIGS. 2C-1 and 2C-2 show a third AR system 200c and third example user interactions using a wrist-wearable device 201, a head-wearable device (e.g., virtual-reality (VR) device 207), and/or an HIPD 205. As the skilled artisan will appreciate upon reading the descriptions provided herein, the above-example AR systems (described in detail below) can perform various functions and/or operations described above with reference to FIG. 1.

The wrist-wearable device 201, the head-wearable devices, and/or the HIPD 205 can communicatively couple via a network 225 (e.g., cellular, near field, Wi-Fi, personal area network, or wireless LAN). Additionally, the wrist-wearable device 201, the head-wearable devices, and/or the HIPD 205 can also communicatively couple with one or more servers 230, computers 240 (e.g., laptops or computers), mobile devices 250 (e.g., smartphones or tablets), and/or other electronic devices via the network 225 (e.g., cellular, near field, Wi-Fi, personal area network, or wireless LAN).

Turning to FIG. 2A, a user 202 is shown wearing the wrist-wearable device 201 and the AR device 203, and having the HIPD 205 on their desk. The wrist-wearable device 201, the AR device 203, and the HIPD 205 facilitate user interaction with an AR environment. In particular, as shown by the first AR system 200a, the wrist-wearable device 201, the AR device 203, and/or the HIPD 205 cause presentation of one or more avatars 204, digital representations of contacts 206, and virtual objects 208. As discussed below, the user 202 can interact with the one or more avatars 204, digital representations of the contacts 206, and virtual objects 208 via the wrist-wearable device 201, the AR device 203, and/or the HIPD 205.

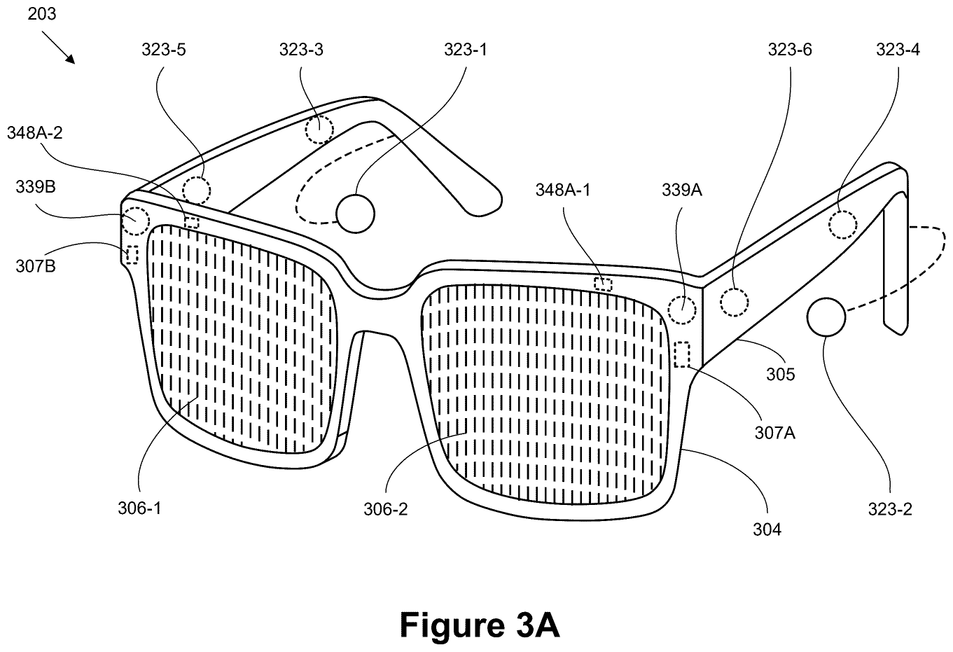

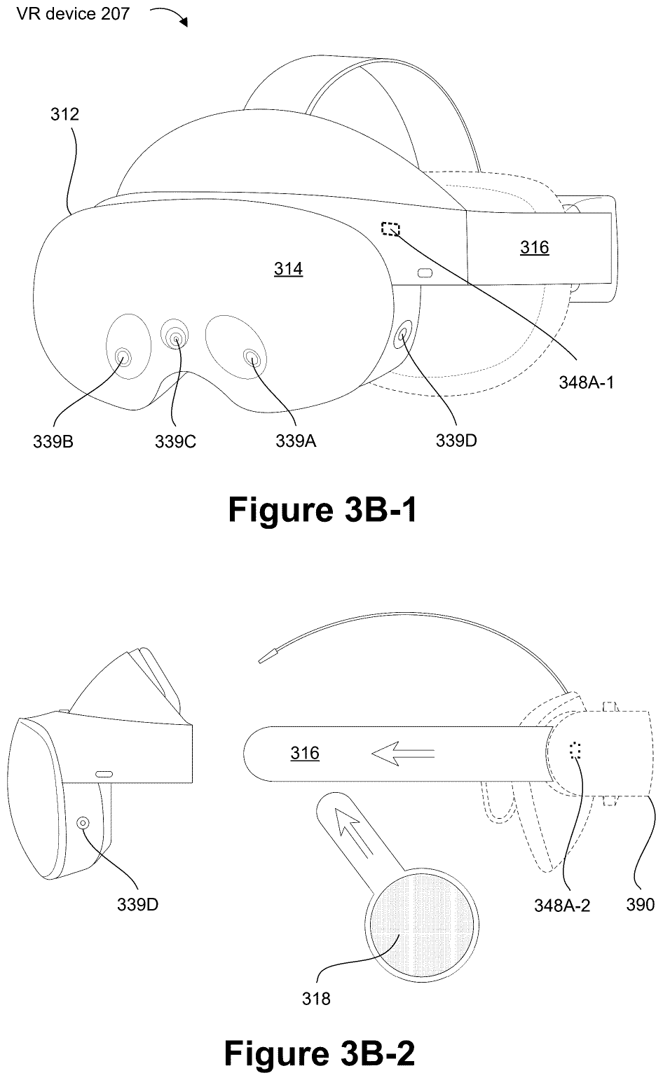

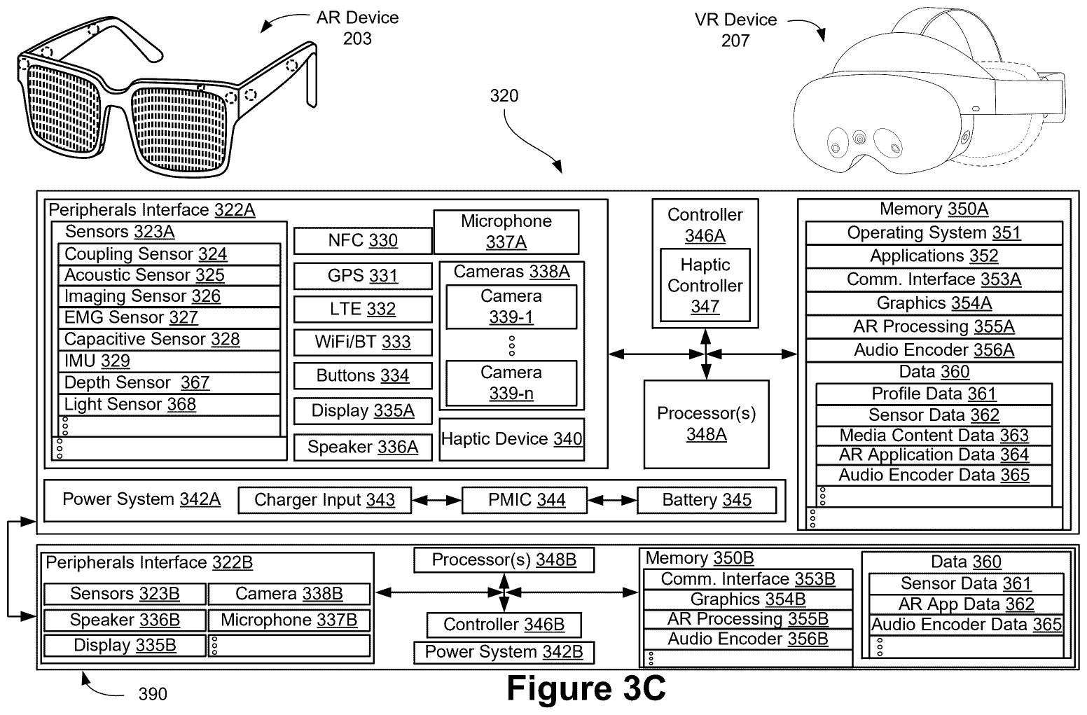

The user 202 can use any of the wrist-wearable device 201, the AR device 203, and/or the HIPD 205 to provide user inputs. For example, the user 202 can perform one or more hand gestures that are detected by the wrist-wearable device 201 (e.g., using one or more EMG sensors and/or IMUs and/or AR device 203 (e.g., using one or more image sensors or cameras, described below in reference to FIGS. 3A-3B) to provide a user input. Alternatively, or additionally, the user 202 can provide a user input via one or more touch surfaces of the wrist-wearable device 201, the AR device 203, and/or the HIPD 205, and/or voice commands captured by a microphone of the wrist-wearable device 201, the AR device 203, and/or the HIPD 205. In some embodiments, the wrist-wearable device 201, the AR device 203, and/or the HIPD 205 include a digital assistant to help the user in providing a user input (e.g., completing a sequence of operations, suggesting different operations or commands, providing reminders, or confirming a command). In some embodiments, the user 202 can provide a user input via one or more facial gestures and/or facial expressions. For example, cameras of the wrist-wearable device 201, the AR device 203, and/or the HIPD 205 can track the user 202's eyes for navigating a user interface.

The wrist-wearable device 201, the AR device 203, and/or the HIPD 205 can operate alone or in conjunction to allow the user 202 to interact with the AR environment. In some embodiments, the HIPD 205 is configured to operate as a central hub or control center for the wrist-wearable device 201, the AR device 203, and/or another communicatively coupled device. For example, the user 202 can provide an input to interact with the AR environment at any of the wrist-wearable device 201, the AR device 203, and/or the HIPD 205, and the HIPD 205 can identify one or more back-end and front-end tasks to cause the performance of the requested interaction and distribute instructions to cause the performance of the one or more back-end and front-end tasks at the wrist-wearable device 201, the AR device 203, and/or the HIPD 205. In some embodiments, a back-end task is a background-processing task that is not perceptible by the user (e.g., rendering content, decompression, or compression), and a front-end task is a user-facing task that is perceptible to the user (e.g., presenting information to the user or providing feedback to the user). The HIPD 205 can perform the back-end tasks and provide the wrist-wearable device 201 and/or the AR device 203 operational data corresponding to the performed back-end tasks such that the wrist-wearable device 201 and/or the AR device 203 can perform the front-end tasks. In this way, the HIPD 205, which has more computational resources and greater thermal headroom than the wrist-wearable device 201 and/or the AR device 203, performs computationally intensive tasks and reduces the computer resource utilization and/or power usage of the wrist-wearable device 201 and/or the AR device 203.

In the example shown by the first AR system 200a, the HIPD 205 identifies one or more back-end tasks and front-end tasks associated with a user request to initiate an AR video call with one or more other users (represented by the avatar 204 and the digital representation of the contact 206) and distributes instructions to cause the performance of the one or more back-end tasks and front-end tasks. In particular, the HIPD 205 performs back-end tasks for processing and/or rendering image data (and other data) associated with the AR video call and provides operational data associated with the performed back-end tasks to the AR device 203 such that the AR device 203 performs front-end tasks for presenting the AR video call (e.g., presenting the avatar 204 and the digital representation of the contact 206).

In some embodiments, the HIPD 205 can operate as a focal or anchor point for causing the presentation of information. This allows the user 202 to be generally aware of where information is presented. For example, as shown in the first AR system 200a, the avatar 204 and the digital representation of the contact 206 are presented above the HIPD 205. In particular, the HIPD 205 and the AR device 203 operate in conjunction to determine a location for presenting the avatar 204 and the digital representation of the contact 206. In some embodiments, information can be presented within a predetermined distance from the HIPD 205 (e.g., within five meters). For example, as shown in the first AR system 200a, virtual object 208 is presented on the desk some distance from the HIPD 205. Similar to the above example, the HIPD 205 and the AR device 203 can operate in conjunction to determine a location for presenting the virtual object 208. Alternatively, in some embodiments, presentation of information is not bound by the HIPD 205. More specifically, the avatar 204, the digital representation of the contact 206, and the virtual object 208 do not have to be presented within a predetermined distance of the HIPD 205.

User inputs provided at the wrist-wearable device 201, the AR device 203, and/or the HIPD 205 are coordinated such that the user can use any device to initiate, continue, and/or complete an operation. For example, the user 202 can provide a user input to the AR device 203 to cause the AR device 203 to present the virtual object 208 and, while the virtual object 208 is presented by the AR device 203, the user 202 can provide one or more hand gestures via the wrist-wearable device 201 to interact and/or manipulate the virtual object 208.

FIG. 2B shows the user 202 wearing the wrist-wearable device 201 and the AR device 203, and holding the HIPD 205. In the second AR system 200b, the wrist-wearable device 201, the AR device 203, and/or the HIPD 205 are used to receive and/or provide one or more messages to a contact of the user 202. In particular, the wrist-wearable device 201, the AR device 203, and/or the HIPD 205 detect and coordinate one or more user inputs to initiate a messaging application and prepare a response to a received message via the messaging application.

In some embodiments, the user 202 initiates, via a user input, an application on the wrist-wearable device 201, the AR device 203, and/or the HIPD 205 that causes the application to initiate on at least one device. For example, in the second AR system 200b, the user 202 performs a hand gesture associated with a command for initiating a messaging application (represented by messaging user interface 212), the wrist-wearable device 201 detects the hand gesture, and, based on a determination that the user 202 is wearing AR device 203, causes the AR device 203 to present a messaging user interface 212 of the messaging application. The AR device 203 can present the messaging user interface 212 to the user 202 via its display (e.g., as shown by user 202's field of view 210). In some embodiments, the application is initiated and can be run on the device (e.g., the wrist-wearable device 201, the AR device 203, and/or the HIPD 205) that detects the user input to initiate the application, and the device provides another device operational data to cause the presentation of the messaging application. For example, the wrist-wearable device 201 can detect the user input to initiate a messaging application, initiate and run the messaging application, and provide operational data to the AR device 203 and/or the HIPD 205 to cause presentation of the messaging application. Alternatively, the application can be initiated and run at a device other than the device that detected the user input. For example, the wrist-wearable device 201 can detect the hand gesture associated with initiating the messaging application and cause the HIPD 205 to run the messaging application and coordinate the presentation of the messaging application.

Further, the user 202 can provide a user input provided at the wrist-wearable device 201, the AR device 203, and/or the HIPD 205 to continue and/or complete an operation initiated at another device. For example, after initiating the messaging application via the wrist-wearable device 201 and while the AR device 203 presents the messaging user interface 212, the user 202 can provide an input at the HIPD 205 to prepare a response (e.g., shown by the swipe gesture performed on the HIPD 205). The user 202's gestures performed on the HIPD 205 can be provided and/or displayed on another device. For example, the user 202's swipe gestures performed on the HIPD 205 are displayed on a virtual keyboard of the messaging user interface 212 displayed by the AR device 203.

In some embodiments, the wrist-wearable device 201, the AR device 203, the HIPD 205, and/or other communicatively coupled devices can present one or more notifications to the user 202. The notification can be an indication of a new message, an incoming call, an application update, a status update, etc. The user 202 can select the notification via the wrist-wearable device 201, the AR device 203, or the HIPD 205 and cause presentation of an application or operation associated with the notification on at least one device. For example, the user 202 can receive a notification that a message was received at the wrist-wearable device 201, the AR device 203, the HIPD 205, and/or other communicatively coupled device and provide a user input at the wrist-wearable device 201, the AR device 203, and/or the HIPD 205 to review the notification, and the device detecting the user input can cause an application associated with the notification to be initiated and/or presented at the wrist-wearable device 201, the AR device 203, and/or the HIPD 205.

While the above example describes coordinated inputs used to interact with a messaging application, the skilled artisan will appreciate upon reading the descriptions that user inputs can be coordinated to interact with any number of applications including, but not limited to, gaming applications, social media applications, camera applications, web-based applications, financial applications, etc. For example, the AR device 203 can present to the user 202 game application data and the HIPD 205 can use a controller to provide inputs to the game. Similarly, the user 202 can use the wrist-wearable device 201 to initiate a camera of the AR device 203, and the user can use the wrist-wearable device 201, the AR device 203, and/or the HIPD 205 to manipulate the image capture (e.g., zoom in or out or apply filters) and capture image data.

Turning to FIGS. 2C-1 and 2C-2, the user 202 is shown wearing the wrist-wearable device 201 and a VR device 207, and holding the HIPD 205. In the third AR system 200c, the wrist-wearable device 201, the VR device 207, and/or the HIPD 205 are used to interact within an AR environment, such as a VR game or other AR application. While the VR device 207 presents a representation of a VR game (e.g., first AR game environment 220) to the user 202, the wrist-wearable device 201, the VR device 207, and/or the HIPD 205 detect and coordinate one or more user inputs to allow the user 202 to interact with the VR game.

In some embodiments, the user 202 can provide a user input via the wrist-wearable device 201, the VR device 207, and/or the HIPD 205 that causes an action in a corresponding AR environment. For example, the user 202 in the third AR system 200c (shown in FIG. 2C-1) raises the HIPD 205 to prepare for a swing in the first AR game environment 220. The VR device 207, responsive to the user 202 raising the HIPD 205, causes the AR representation of the user 222 to perform a similar action (e.g., raise a virtual object, such as a virtual sword 224). In some embodiments, each device uses respective sensor data and/or image data to detect the user input and provide an accurate representation of the user 202's motion. For example, imaging sensors (e.g., SLAM cameras or other cameras of the HIPD 205 can be used to detect a position of the HIDP 205 relative to the user 202's body such that the virtual object can be positioned appropriately within the first AR game environment 220; sensor data from the wrist-wearable device 201 can be used to detect a velocity at which the user 202 raises the HIPD 205 such that the AR representation of the user 222 and the virtual sword 224 are synchronized with the user 202's movements; and image sensors 326 (FIGS. 3A-3C) of the VR device 207 can be used to represent the user 202's body, boundary conditions, or real-world objects within the first AR game environment 220.

In FIG. 2C-2, the user 202 performs a downward swing while holding the HIPD 205. The user 202's downward swing is detected by the wrist-wearable device 201, the VR device 207, and/or the HIPD 205 and a corresponding action is performed in the first AR game environment 220. In some embodiments, the data captured by each device is used to improve the user's experience within the AR environment. For example, sensor data of the wrist-wearable device 201 can be used to determine a speed and/or force at which the downward swing is performed and image sensors of the HIPD 205 and/or the VR device 207 can be used to determine a location of the swing and how it should be represented in the first AR game environment 220, which, in turn, can be used as inputs for the AR environment (e.g., game mechanics, which can use detected speed, force, locations, and/or aspects of the user 202's actions to classify a user's inputs (e.g., user performs a light strike, hard strike, critical strike, glancing strike, miss) or calculate an output (e.g., amount of damage)).

While the wrist-wearable device 201, the VR device 207, and/or the HIPD 205 are described as detecting user inputs, in some embodiments, user inputs are detected at a single device (with the single device being responsible for distributing signals to the other devices for performing the user input). For example, the HIPD 205 can operate an application for generating the first AR game environment 220 and provide the VR device 207 with corresponding data for causing the presentation of the first AR game environment 220, as well as detect the 202's movements (while holding the HIPD 205) to cause the performance of corresponding actions within the first AR game environment 220. Additionally or alternatively, in some embodiments, operational data (e.g., sensor data, image data, application data, device data, and/or other data) of one or more devices is provide to a single device (e.g., the HIPD 205) to process the operational data and cause respective devices to perform an action associated with processed operational data.

In FIGS. 2D-1 and 2D-2, the user 202 is shown wearing the wrist-wearable device 201, the VR device 207, and smart textile-based garments 209. In the fourth AR system 200d, the wrist-wearable device 201, the VR device 207, and/or the smart textile-based garments 209 are used to interact within an AR environment (e.g., any AR system described above in reference to FIGS. 2A-2C-2). While the VR device 207 presents a representation of a VR game (e.g., second AR game environment 235) to the user 202, the wrist-wearable device 201, the VR device 207, and/or the smart textile-based garments 209 detect and coordinate one or more user inputs to allow the user 202 to interact with the AR environment.

In some embodiments, the user 202 can provide a user input via the wrist-wearable device 201, the VR device 207, and/or the smart textile-based garments 209 that causes an action in a corresponding AR environment. For example, the user 202 in the fourth AR system 200d (shown in FIG. 2D-1) raises a hand wearing the smart textile-based garments 209 to prepare to cast a spell or throw an object within the second AR game environment 235. The VR device 207, responsive to the user 202 holding up their hand (wearing smart textile-based garments 209), causes the AR representation of the user 222 to perform a similar action (e.g., hold a virtual object or throw a fireball 234). In some embodiments, each device uses respective sensor data and/or image data to detect the user input and provides an accurate representation of the user 202's motion.

In FIG. 2D-2, the user 202 performs a throwing motion while wearing the smart textile-based garment 209. The user 202's throwing motion is detected by the wrist-wearable device 201, the VR device 207, and/or the smart textile-based garments 209, and a corresponding action is performed in the second AR game environment 235. As described above, the data captured by each device is used to improve the user's experience within the AR environment. Although not shown, the smart textile-based garments 209 can be used in conjunction with an AR device 207 and/or an HIPD 205.

Having discussed example AR systems, devices for interacting with such AR systems, and other computing systems more generally, devices and components will now be discussed in greater detail below. Some definitions of devices and components that can be included in some or all of the example devices discussed below are defined here for ease of reference. A skilled artisan will appreciate that certain types of the components described below may be more suitable for a particular set of devices and less suitable for a different set of devices. But subsequent references to the components defined here should be considered to be encompassed by the definitions provided.

In some embodiments discussed below, example devices and systems, including electronic devices and systems, will be discussed. Such example devices and systems are not intended to be limiting, and one of skill in the art will understand that alternative devices and systems to the example devices and systems described herein may be used to perform the operations and construct the systems and devices that are described herein.

As described herein, an electronic device is a device that uses electrical energy to perform a specific function. It can be any physical object that contains electronic components such as transistors, resistors, capacitors, diodes, and integrated circuits. Examples of electronic devices include smartphones, laptops, digital cameras, televisions, gaming consoles, and music players, as well as the example electronic devices discussed herein. As described herein, an intermediary electronic device is a device that sits between two other electronic devices and/or a subset of components of one or more electronic devices, which facilitates communication, and/or data processing, and/or data transfer between the respective electronic devices and/or electronic components.

### Example Head-Wearable Devices

FIGS. 3A, 3B-1, 3B-2, and 3C show example head-wearable devices, in accordance with some embodiments. Head-wearable devices can include, but are not limited to, AR devices 203 (e.g., AR or smart eyewear devices, such as smart glasses, smart monocles, smart contacts, etc.), VR devices 207 (e.g., VR headsets or head-mounted displays (HMDs)), or other ocularly coupled devices. The AR devices 203 and the VR devices 207 are instances of the head-wearable devices described in reference to FIG. 1 herein, such that the head-wearable device should be understood to have the features of the AR devices 203 and/or the VR devices 207 and vice versa. The AR devices 203 and the VR devices 207 can perform various functions and/or operations associated with navigating through user interfaces and selectively opening applications, as well as the functions and/or operations described above with reference to FIG. 1.

In some embodiments, an AR system (e.g., FIGS. 2A-2D-2; AR systems 200a-200d) includes an AR device 203 (as shown in FIG. 3A) and/or VR device 207 (as shown in FIGS. 3B-1-B-2). In some embodiments, the AR device 203 and the VR device 207 can include one or more analogous components (e.g., components for presenting interactive AR environments, such as processors, memory, and/or presentation devices, including one or more displays and/or one or more waveguides), some of which are described in more detail with respect to FIG. 3C. The head-wearable devices can use display projectors (e.g., display projector assemblies 307A and 307B) and/or waveguides for projecting representations of data to a user. Some embodiments of head-wearable devices do not include displays.

FIG. 3A shows an example visual depiction of the AR device 203 (e.g., which may also be described herein as augmented-reality glasses and/or smart glasses). The AR device 203 can work in conjunction with additional electronic components that are not shown in FIGS. 3A, such as a wearable accessory device and/or an intermediary processing device, in electronic communication or otherwise configured to be used in conjunction with the AR device 203. In some embodiments, the wearable accessory device and/or the intermediary processing device may be configured to couple with the AR device 203 via a coupling mechanism in electronic communication with a coupling sensor 324, where the coupling sensor 324 can detect when an electronic device becomes physically or electronically coupled with the AR device 203. In some embodiments, the AR device 203 can be configured to couple to a housing (e.g., a portion of frame 304 or temple arms 305), which may include one or more additional coupling mechanisms configured to couple with additional accessory devices. The components shown in FIG. 3A can be implemented in hardware, software, firmware, or a combination thereof, including one or more signal-processing components and/or application-specific integrated circuits (ASICs).

The AR device 203 includes mechanical glasses components, including a frame 304 configured to hold one or more lenses (e.g., one or both lenses 306-1 and 306-2). One of ordinary skill in the art will appreciate that the AR device 203 can include additional mechanical components, such as hinges configured to allow portions of the frame 304 of the AR device 203 to be folded and unfolded, a bridge configured to span the gap between the lenses 306-1 and 306-2 and rest on the user's nose, nose pads configured to rest on the bridge of the nose and provide support for the AR device 203, earpieces configured to rest on the user's ears and provide additional support for the AR device 203, temple arms 305 configured to extend from the hinges to the earpieces of the AR device 203, and the like. One of ordinary skill in the art will further appreciate that some examples of the AR device 203 can include none of the mechanical components described herein. For example, smart contact lenses configured to present AR to users may not include any components of the AR device 203.

The lenses 306-1 and 306-2 can be individual displays or display devices (e.g., a waveguide for projected representations). The lenses 306-1 and 306-2 may act together or independently to present an image or series of images to a user. In some embodiments, the lenses 306-1 and 306-2 can operate in conjunction with one or more display projector assemblies 307A and 307B to present image data to a user. While the AR device 203 includes two displays, embodiments of this disclosure may be implemented in AR devices with a single near-eye display (NED) or more than two NEDs.

The AR device 203 includes electronic components, many of which will be described in more detail below with respect to FIG. 3C. Some example electronic components are illustrated in FIG. 3A, including sensors 323-1, 323-2, 323-3, 323-4, 323-5, and 323-6, which can be distributed along a substantial portion of the frame 304 of the AR device 203. The different types of sensors are described below in reference to FIG. 3C. The AR device 203 also includes a left camera 339A and a right camera 339B, which are located on different sides of the frame 304. And the eyewear device includes one or more processors 348A and 348B (e.g., an integral microprocessor, such as an ASIC) that is embedded into a portion of the frame 304.

FIGS. 3B-1 and 3B-2 show an example visual depiction of the VR device 207 (e.g., a head-mounted display (HMD) 312, also referred to herein as an AR headset, a head-wearable device, or a VR headset). The HMD 312 includes a front body 314 and a frame 316 (e.g., a strap or band) shaped to fit around a user's head. In some embodiments, the front body 314 and/or the frame 316 includes one or more electronic elements for facilitating presentation of and/or interactions with an AR and/or VR system (e.g., displays, processors (e.g., processor 348A-1), IMUs, tracking emitters or detectors, or sensors). In some embodiments, the HMD 312 includes output audio transducers (e.g., an audio transducer 318-1), as shown in FIG. 3B-2. In some embodiments, one or more components, such as the output audio transducer(s) 318 and the frame 316, can be configured to attach and detach (e.g., are detachably attachable) to the HMD 312 (e.g., a portion or all of the frame 316 and/or the output audio transducer 318), as shown in FIG. 3B-2. In some embodiments, coupling a detachable component to the HMD 312 causes the detachable component to come into electronic communication with the HMD 312. The VR device 207 includes electronic components, many of which will be described in more detail below with respect to FIG. 3C.

FIGS. 3B-1 and 3B-2 also show that the VR device 207 having one or more cameras, such as the left camera 339A and the right camera 339B, which can be analogous to the left and right cameras on the frame 304 of the AR device 203. In some embodiments, the VR device 207 includes one or more additional cameras (e.g., cameras 339C and 339D), which can be configured to augment image data obtained by the cameras 339A and 339B by providing more information. For example, the camera 339C can be used to supply color information that is not discerned by cameras 339A and 339B. In some embodiments, one or more of the cameras 339A to 339D can include an optional IR (infrared) cut filter configured to remove IR light from being received at the respective camera sensors.

The VR device 207 can include a housing 390 storing one or more components of the VR device 207 and/or additional components of the VR device 207. The housing 390 can be a modular electronic device configured to couple with the VR device 207 (or an AR device 203) and supplement and/or extend the capabilities of the VR device 207 (or an AR device 203). For example, the housing 390 can include additional sensors, cameras, power sources, and processors (e.g., processor 348A-2) to improve and/or increase the functionality of the VR device 207. Examples of the different components included in the housing 390 are described below in reference to FIG. 3C.

Alternatively, or in addition, in some embodiments, the head-wearable device, such as the VR device 207 and/or the AR device 203, includes, or is communicatively coupled to, another external device (e.g., a paired device), such as an HIPD device 205 and/or an optional neckband. The optional neckband can couple to the head-wearable device via one or more connectors (e.g., wired or wireless connectors). The head-wearable device and the neckband can operate independently without any wired or wireless connection between them. In some embodiments, the components of the head-wearable device and the neckband are located on one or more additional peripheral devices paired with the head-wearable device, the neckband, or some combination thereof. Furthermore, the neckband is intended to represent any suitable type or form of paired device. Thus, the following discussion of neckbands may also apply to various other paired devices, such as smartwatches, smartphones, wrist bands, other wearable devices, hand-held controllers, tablet computers, or laptop computers.

In some situations, pairing external devices, such as an intermediary processing device (e.g., an HIPD device 205, an optional neckband, and/or a wearable accessory device) with the head-wearable devices (e.g., an AR device 203 and/or a VR device 207) enables the head-wearable devices to achieve a similar form factor of a pair of glasses while still providing sufficient battery and computational power for expanded capabilities. Some, or all, of the battery power, computational resources, and/or additional features of the head-wearable devices can be provided by a paired device or shared between a paired device and the head-wearable devices, thus reducing the weight, heat profile, and form factor of the head-wearable device overall while allowing the head-wearable device to retain its desired functionality. For example, the intermediary processing device (e.g., the HIPD 205) can allow components that would otherwise be included in a head-wearable device to be included in the intermediary processing device (and/or a wearable device or accessory device), thereby shifting a weight load from the user's head and neck to one or more other portions of the user's body. In some embodiments, the intermediary processing device has a larger surface area over which to diffuse and disperse heat to the ambient environment. Thus, the intermediary processing device can allow for greater battery and computational capacity than might otherwise have been possible on the head-wearable devices, standing alone. Because weight carried in the intermediary processing device can be less invasive to a user than weight carried in the head-wearable devices, a user may tolerate wearing a lighter eyewear device and carrying or wearing the paired device for greater lengths of time than the user would tolerate wearing a heavier eyewear device standing alone, thereby enabling an AR environment to be incorporated more fully into a user's day-to-day activities.

In some embodiments, the intermediary processing device is communicatively coupled with the head-wearable device and/or to other devices. The other devices may provide certain functions (e.g., tracking, localizing, depth mapping, processing, and/or storage) to the head-wearable device. In some embodiments, the intermediary processing device includes a controller and a power source. In some embodiments, sensors of the intermediary processing device are configured to sense additional data that can be shared with the head-wearable devices in an electronic format (analog or digital).

The controller of the intermediary processing device processes information generated by the sensors on the intermediary processing device and/or the head-wearable devices. The intermediary processing device, such as an HIPD 205, can process information generated by one or more of its sensors and/or information provided by other communicatively coupled devices. For example, a head-wearable device can include an IMU, and the intermediary processing device (a neckband and/or an HIPD 205) can compute all inertial and spatial calculations from the IMUs located on the head-wearable device. Additional examples of processing performed by a communicatively coupled device, such as the HIPD 205.

AR systems may include a variety of types of visual feedback mechanisms. For example, display devices in the AR devices 203 and/or the VR devices 207 may include one or more liquid-crystal displays (LCDs), light emitting diode (LED) displays, organic LED (OLED) displays, and/or any other suitable type of display screen. AR systems may include a single display screen for both eyes or may provide a display screen for each eye, which may allow for additional flexibility for varifocal adjustments or for correcting a refractive error associated with the user's vision. Some AR systems also include optical subsystems having one or more lenses (e.g., conventional concave or convex lenses, Fresnel lenses, or adjustable liquid lenses) through which a user may view a display screen. In addition to or instead of using display screens, some AR systems include one or more projection systems. For example, display devices in the AR device 203 and/or the VR device 207 may include micro-LED projectors that project light (e.g., using a waveguide) into display devices, such as clear combiner lenses that allow ambient light to pass through. The display devices may refract the projected light toward a user's pupil and may enable a user to simultaneously view both AR content and the real world. AR systems may also be configured with any other suitable type or form of image projection system. As noted, some AR systems may, instead of blending an artificial reality with actual reality, substantially replace one or more of a user's sensory perceptions of the real world with a virtual experience.

While the example head-wearable devices are respectively described herein as the AR device 203 and the VR device 207, either or both of the example head-wearable devices described herein can be configured to present fully immersive VR scenes presented in substantially all of a user's field of view, additionally or alternatively to, subtler augmented-reality scenes that are presented within a portion, less than all, of the user's field of view.

In some embodiments, the AR device 203 and/or the VR device 207 can include haptic feedback systems. The haptic feedback systems may provide various types of cutaneous feedback, including vibration, force, traction, shear, texture, and/or temperature. The haptic feedback systems may also provide various types of kinesthetic feedback, such as motion and compliance. The haptic feedback can be implemented using motors, piezoelectric actuators, fluidic systems, and/or a variety of other types of feedback mechanisms. The haptic feedback systems may be implemented independently of other AR devices, within other AR devices, and/or in conjunction with other AR devices (e.g., wrist-wearable devices that may be incorporated into headwear, gloves, body suits, handheld controllers, environmental devices (e.g., chairs or floormats), and/or any other type of device or system, such as a wrist-wearable device 201, an HIPD 205, smart textile-based garment 209), and/or other devices described herein.

FIG. 3C illustrates a computing system 320 and an optional housing 390, each of which shows components that can be included in a head-wearable device (e.g., the AR device 203 and/or the VR device 207). In some embodiments, more or fewer components can be included in the optional housing 390 depending on practical restraints of the respective head-wearable device being described. Additionally or alternatively, the optional housing 390 can include additional components to expand and/or augment the functionality of a head-wearable device.

In some embodiments, the computing system 320 and/or the optional housing 390 can include one or more peripheral interfaces 322A and 322B, one or more power systems 342A and 342B (including charger input 343, PMIC 344, and battery 345), one or more controllers 346A and 346B (including one or more haptic controllers 347), one or more processors 348A and 348B (as defined above, including any of the examples provided), and memory 350A and 350B, which can all be in electronic communication with each other. For example, the one or more processors 348A and/or 348B can be configured to execute instructions stored in the memory 350A and/or 350B, which can cause a controller of the one or more controllers 346A and/or 346B to cause operations to be performed at one or more peripheral devices of the peripherals interfaces 322A and/or 322B. In some embodiments, each operation described can occur based on electrical power provided by the power system 342A and/or 342B.

In some embodiments, the peripherals interface 322A can include one or more devices configured to be part of the computing system 320, many of which have been defined above and/or described with respect to wrist-wearable devices. For example, the peripherals interface can include one or more sensors 323A. Some example sensors include one or more coupling sensors 324, one or more acoustic sensors 325, one or more imaging sensors 326, one or more EMG sensors 327, one or more capacitive sensors 328, and/or one or more IMUs 329. In some embodiments, the sensors 323A further include depth sensors 367, light sensors 368, and/or any other types of sensors defined above or described with respect to any other embodiments discussed herein.

In some embodiments, the peripherals interface can include one or more additional peripheral devices, including one or more NFC devices 330, one or more GPS devices 331, one or more LTE devices 332, one or more Wi-Fi and/or Bluetooth devices 333, one or more buttons 334 (e.g., including buttons that are slidable or otherwise adjustable), one or more displays 335A, one or more speakers 336A, one or more microphones 337A, one or more cameras 338A (e.g., including the first camera 339-1 through nth camera 339-n, which are analogous to the left camera 339A and/or the right camera 339B), one or more haptic devices 340, and/or any other types of peripheral devices defined above or described with respect to any other embodiments discussed herein.

The head-wearable devices can include a variety of types of visual feedback mechanisms (e.g., presentation devices). For example, display devices in the AR device 203 and/or the VR device 207 can include one or more liquid-crystal displays (LCDs), light emitting diode (LED) displays, organic LED (OLED) displays, micro-LEDs, and/or any other suitable types of display screens. The head-wearable devices can include a single display screen (e.g., configured to be seen by both eyes) and/or can provide separate display screens for each eye, which can allow for additional flexibility for varifocal adjustments and/or for correcting a refractive error associated with the user's vision. Some embodiments of the head-wearable devices also include optical subsystems having one or more lenses (e.g., conventional concave or convex lenses, Fresnel lenses, or adjustable liquid lenses) through which a user can view a display screen. For example, respective displays 335A can be coupled to each of the lenses 306-1 and 306-2 of the AR device 203. The displays 335A coupled to each of the lenses 306-1 and 306-2 can act together or independently to present an image or series of images to a user. In some embodiments, the AR device 203 and/or the VR device 207 includes a single display 335A (e.g., a near-eye display) or more than two displays 335A.

In some embodiments, a first set of one or more displays 335A can be used to present an augmented-reality environment, and a second set of one or more display devices 335A can be used to present a VR environment. In some embodiments, one or more waveguides are used in conjunction with presenting AR content to the user of the AR device 203 and/or the VR device 207 (e.g., as a means of delivering light from a display projector assembly and/or one or more displays 335A to the user's eyes). In some embodiments, one or more waveguides are fully or partially integrated into the AR device 203 and/or the VR device 207. Additionally, or alternatively, to display screens, some AR systems include one or more projection systems. For example, display devices in the AR device 203 and/or the VR device 207 can include micro-LED projectors that project light (e.g., using a waveguide) into display devices, such as clear combiner lenses that allow ambient light to pass through. The display devices can refract the projected light toward a user's pupil and can enable a user to simultaneously view both AR content and the real world. The head-wearable devices can also be configured with any other suitable type or form of image projection system. In some embodiments, one or more waveguides are provided, additionally or alternatively, to the one or more display(s) 335A.

In some embodiments of the head-wearable devices, ambient light and/or a real-world live view (e.g., a live feed of the surrounding environment that a user would normally see) can be passed through a display element of a respective head-wearable device presenting aspects of the AR system. In some embodiments, ambient light and/or the real-world live view can be passed through a portion, less than all, of an AR environment presented within a user's field of view (e.g., a portion of the AR environment co-located with a physical object in the user's real-world environment that is within a designated boundary (e.g., a guardian boundary) configured to be used by the user while they are interacting with the AR environment). For example, a visual user interface element (e.g., a notification user interface element) can be presented at the head-wearable devices, and an amount of ambient light and/or the real-world live view (e.g., 15%-50% of the ambient light and/or the real-world live view) can be passed through the user interface element, such that the user can distinguish at least a portion of the physical environment over which the user interface element is being displayed.

The head-wearable devices can include one or more external displays 335A for presenting information to users. For example, an external display 335A can be used to show a current battery level, network activity (e.g., connected, disconnected), current activity (e.g., playing a game, in a call, in a meeting, or watching a movie), and/or other relevant information. In some embodiments, the external displays 335A can be used to communicate with others. For example, a user of the head-wearable device can cause the external displays 335A to present a “do not disturb” notification. The external displays 335A can also be used by the user to share any information captured by the one or more components of the peripherals interface 322A and/or generated by the head-wearable device (e.g., during operation and/or performance of one or more applications).

The memory 350A can include instructions and/or data executable by one or more processors 348A (and/or processors 348B of the housing 390) and/or a memory controller of the one or more controllers 346A (and/or controller 346B of the housing 390). The memory 350A can include one or more operating systems 351, one or more applications 352, one or more communication interface modules 353A, one or more graphics modules 354A, one or more AR processing modules 355A, audio encoder module 356 for including instructions to cause performance of the flow diagram described in reference to FIG. 1, and/or any other types of modules or components defined above or described with respect to any other embodiments discussed herein.

The data 360 stored in memory 350A can be used in conjunction with one or more of the applications and/or programs discussed above. The data 360 can include profile data 361, sensor data 362, media content data 363, AR application data 364, audio encoder data 365; and/or any other types of data defined above or described with respect to any other embodiments discussed herein.

In some embodiments, the controller 346A of the head-wearable devices processes information generated by the sensors 323A on the head-wearable devices and/or another component of the head-wearable devices and/or communicatively coupled with the head-wearable devices (e.g., components of the housing 390, such as components of peripherals interface 322B). For example, the controller 346A can process information from the acoustic sensors 325 and/or image sensors 326. For each detected sound, the controller 346A can perform a direction of arrival (DOA) estimation to estimate a direction from which the detected sound arrived at a head-wearable device. As one or more of the acoustic sensors 325 detect sounds, the controller 346A can populate an audio data set with the information (e.g., represented by sensor data 362).

In some embodiments, a physical electronic connector can convey information between the head-wearable devices and another electronic device, and/or between one or more processors 348A of the head-wearable devices and the controller 346A. The information can be in the form of optical data, electrical data, wireless data, or any other transmittable data form. Moving the processing of information generated by the head-wearable devices to an intermediary processing device can reduce weight and heat in the eyewear device, making it more comfortable and safer for a user. In some embodiments, an optional accessory device (e.g., an electronic neckband or an HIPD 205) is coupled to the head-wearable devices via one or more connectors. The connectors can be wired or wireless connectors and can include electrical and/or non-electrical (e.g., structural) components. In some embodiments, the head-wearable devices and the accessory device can operate independently without any wired or wireless connection between them.

The head-wearable devices can include various types of computer vision components and subsystems. For example, the AR device 203 and/or the VR device 207 can include one or more optical sensors such as two-dimensional (2D) or three-dimensional (3D) cameras, ToF depth sensors, single-beam or sweeping laser rangefinders, 3D LiDAR sensors, and/or any other suitable type or form of optical sensor. A head-wearable device can process data from one or more of these sensors to identify a location of a user and/or aspects of the user's real-world physical surroundings, including the locations of real-world objects within the real-world physical surroundings. In some embodiments, the methods described herein are used to map the real world, to provide a user with context about real-world surroundings, and/or to generate interactable virtual objects (which can be replicas or digital twins of real-world objects that can be interacted with an AR environment), among a variety of other functions. For example, FIGS. 3B-1 and 3B-2 show the VR device 207 having cameras 339A-339D, which can be used to provide depth information for creating a voxel field and a 2D mesh to provide object information to the user to avoid collisions.

The optional housing 390 can include analogous components to those describe above with respect to the computing system 320. For example, the optional housing 390 can include a respective peripherals interface 322B, including more or fewer components to those described above with respect to the peripherals interface 322A. As described above, the components of the optional housing 390 can be used to augment and/or expand on the functionality of the head-wearable devices. For example, the optional housing 390 can include respective sensors 323B, speakers 336B, displays 335B, microphones 337B, cameras 338B, and/or other components to capture and/or present data. Similarly, the optional housing 390 can include one or more processors 348B, controllers 346B, and/or memory 350B (including respective communication interface modules 353B, one or more graphics modules 354B, one or more AR processing modules 355B) that can be used individually and/or in conjunction with the components of the computing system 320.

The techniques described above in FIGS. 3A-3C can be used with different head-wearable devices. In some embodiments, the head-wearable devices (e.g., the AR device 203 and/or the VR device 207) can be used in conjunction with one or more wearable devices such as a wrist-wearable device 201 (or components thereof).

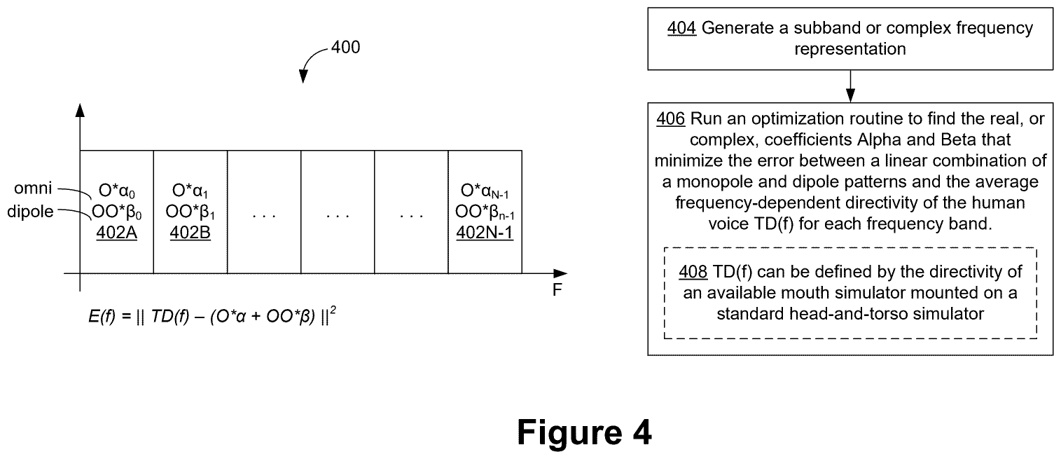

FIG. 4 illustrates a functional model of the directivity of human voice, in accordance with some embodiments. In some embodiments, the functional model of the directivity of human voice can be represented by a frequency dependent weighted combination of monopole source and a dipole source (404). This is illustrated by graph 400, which shows a representation of how the equation, shown below, is applied to each frequency band (402A, 402B, . . . , 402N-1) of a human's voice to minimizes error between the combination of monopole and dipole patterns.

e(f)=∥TD(f)−(monopole(f)*α+dipole(f)*β)∥

The above equation provides a calculation for each frequency band of a human's voice, where the error, represented by “e(f)” is minimized. This is done by running an optimization routine to find real, complex, coefficients of alpha and beta that minimizes the error between a liner combination of a monopole and dipole patterns (406). In the above equation, TD(f) represents an average frequency-dependent directivity of the human voice. In some embodiments, the TD(f) can be defined by the directivity of an available mouth simulator mounted on a standard head-and-torso simulator (408).

In addition to the above, additional inputs can be used to reduce error. In some embodiments, room acoustic simulations can implement solvers that solve the wave equation or apply geometrical acoustics, like the mirror-image method or ray tracing method which can simulate the response from a sound source to an omnidirectional receiver.

In some embodiments, the resulting room impulse response (RIR) is separated into the direct path and the reflected path. The direct path depends only on the distance between the sound source and the receiver and their corresponding orientations. In some embodiments, it does not depend on the room itself. Separating the RIR into direct- and reflected-path can be achieved by peak search methods like identifying the onset of the impulse response as the energy that is 5 or 10% above of the noise floor. In some embodiments, the noise floor can be computed by the rms of the portion of the RIR that represents the propagation delay between sound source and receiver.

In some embodiments, time alignment through cross-correlation can be implemented in the time domain by identify the argument of the maximum of the cross-correlation function between the direct-path of the RIR and the near-field (NF) impulse responses.

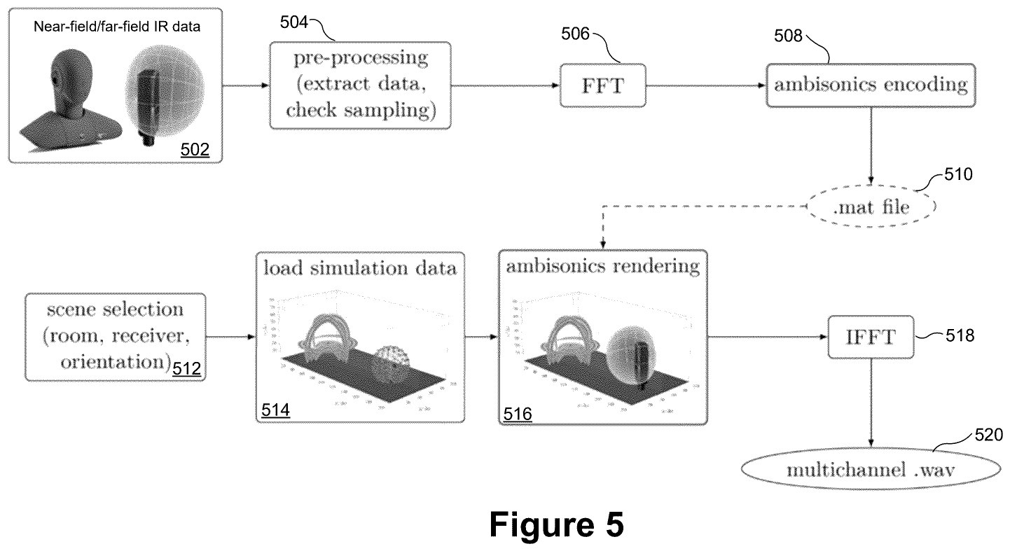

FIG. 5 illustrates a high-order ambisonics decomposition, in accordance with some embodiments. FIG. 5 illustrates that near field and far field IR data input file (e.g., a spatially oriented format for acoustics (SOFA) file) is received (502), or any other suitable file. From there the input file is preprocessed (e.g., by extracting the data, check sampling, etc.) (504). After preprocessing is complete, a fast Fourier transform (FFT) is applied to the preprocessed data (506). After the FFT is applied ambisonics encoding takes place and a.mat file is produced that includes the encoded ambisonics.

FIG. 5 then illustrates that a room response is represented by scene selection (room, receiver, orientation) (512). From there simulation data is loaded (514), and the simulation data can include time-aligned reflected-path of the RIR. After the simulation data is loaded it is loaded along with the as measured/simulated Far-field (FF) impulse responses of a target device or head (i.e. the SOFA input file (e.g., the .mat file)) are encoded/combined/rendered into high-order ambisonics. The rendering is done in such a way that the directional effect of multiple room reflections are convolved with the FF impulse response corresponding to those directions (514).

After the ambisonics rendering is finished the data is decoded and converted back into time domain via the inverse FFT (IFFT) (518) to generate device-related RIR, which is represented by a multichannel .wav file (520).

Any data collection performed by the devices described herein and/or any devices configured to perform or cause the performance of the different embodiments described above in reference to any of the Figures, hereinafter the “devices,” is done with user consent and in a manner that is consistent with all applicable privacy laws. Users are given options to allow the devices to collect data, as well as the option to limit or deny collection of data by the devices. A user is able to opt in or opt out of any data collection at any time. Further, users are given the option to request the removal of any collected data.

It will be understood that, although the terms “first,” “second,” etc., may be used herein to describe various elements, these elements should not be limited by these terms. These terms are only used to distinguish one element from another.

The terminology used herein is for the purpose of describing particular embodiments only and is not intended to be limiting of the claims. As used in the description of the embodiments and the appended claims, the singular forms “a,” “an” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

As used herein, the term “if” can be construed to mean “when” or “upon” or “in response to determining” or “in accordance with a determination” or “in response to detecting,” that a stated condition precedent is true, depending on the context. Similarly, the phrase “if it is determined [that a stated condition precedent is true]” or “if [a stated condition precedent is true]” or “when [a stated condition precedent is true]” can be construed to mean “upon determining” or “in response to determining” or “in accordance with a determination” or “upon detecting” or “in response to detecting” that the stated condition precedent is true, depending on the context.

The foregoing description, for purpose of explanation, has been described with reference to specific embodiments. However, the illustrative discussions above are not intended to be exhaustive or to limit the claims to the precise forms disclosed. Many modifications and variations are possible in view of the above teachings. The embodiments were chosen and described in order to best explain principles of operation and practical applications, to thereby enable others skilled in the art.

What is claimed is:

1. A method of matching audio inputs to an extended-reality environment, comprising:
receiving an audio input from a microphone at a head-worn extended-reality device worn by a user, wherein (i) the audio input is received while the user is at a location in a simulated environment and (ii) the audio input includes a representation of the user's voice;
processing the audio input into processed audio by changing the audio input based on simulated objects within the simulated environment, wherein the processed audio is configured to be perceived by the user in a manner as if the audio input is being altered by the simulated environment; and
transmitting the processed audio to the head-worn extended-reality device for playback, such that the processed audio is perceived as being spoken by the user in the simulated environment.

2. The method of claim 1, including:
receiving the audio input from the microphone at a head-worn extended-reality device worn by a user, wherein (i) the audio input is received while the user is at another location in the simulated environment and (ii) the audio input includes the representation of the user's voice;
processing the audio input into another processed audio by changing the audio input based on the simulated objects within the simulated environment, wherein the processed audio is configured to be perceived by the user in a manner as if the audio input is being altered by the simulated environment; and
transmitting the other processed audio to the head-worn extended-reality device for playback, such that the other processed audio is perceived as being spoken by the user in the simulated environment at the other location.

3. The method of claim 2, wherein the simulated environment includes a plurality of simulated objects that each have different acoustical properties, wherein the acoustical properties are defined by one or more of a simulated shape, a simulated material, and a simulated distance from the user in the simulated environment.

4. The method of claim 1, wherein processing the audio input includes producing a direct path impulse response (IR) and a reflected room impulse response (RIR) based on a directionality of an audio source at the location in the simulated environment.

5. The method of claim 2, wherein processing the audio input includes cross-correlating the direct path IR with the audio input to identify a time misalignment.

6. The method of claim 5, wherein processing the audio input includes time aligning the reflected RIR with the audio input based on the time misalignment to produce time-aligned reflected RIR.

7. The method of claim 6, wherein processing the audio input includes decomposing the time-aligned reflected RIR and the audio input to produce high-order ambisonics (HoA).

8. The method of claim 7, wherein processing the audio input includes generating a hybrid RIR based on the HoA, wherein the hybrid RIR includes only reflected HoA components.

9. The method of claim 8, wherein processing the audio input includes rendering multichannel audio in an ambisonic domain based on the hybrid RIR.

10. The method of claim 9, wherein processing the audio input includes concatenating the multichannel audio and the received audio input to produce a concatenated audio transmission corresponding to a simulated extended reality environment.

11. The method of claim 1, wherein the processed audio includes noise cancelling audio to cancel out reverberated audio from a physical environment in which the head-worn extended-reality device is placed.

12. A non-transitory computer-readable storage medium comprising instructions, that when executed by a head-worn extended-reality system, cause the head-worn extended-reality system to:
receive an audio input from a microphone at a head-worn extended-reality device worn by a user, wherein (i) the audio input is received while the user is at a location in a simulated environment and (ii) the audio input includes a representation of the user's voice;
process the audio input into processed audio by changing the audio input based on simulated objects within the simulated environment, wherein the processed audio is configured to be perceived by the user in a manner as if the audio input is being altered by the simulated environment; and
transmit the processed audio to the head-worn extended-reality device for playback, such that the processed audio is perceived as being spoken by the user in the simulated environment.

13. The non-transitory computer-readable storage medium of claim 12, wherein the instructions, that when executed, further cause the system to:
receive the audio input from the microphone at a head-worn extended-reality device worn by a user, wherein (i) the audio input is received while the user is at another location in the simulated environment and (ii) the audio input includes the representation of the user's voice;
process the audio input into another processed audio by changing the audio input based on the simulated objects within the simulated environment, wherein the processed audio is configured to be perceived by the user in a manner as if the audio input is being altered by the simulated environment; and
transmit the other processed audio to the head-worn extended-reality device for playback, such that the other processed audio is perceived as being spoken by the user in the simulated environment at the other location.

14. The non-transitory computer-readable storage medium of claim 13, wherein the simulated environment includes a plurality of simulated objects that each have different acoustical properties, wherein the acoustical properties are defined by one or more of a simulated shape, a simulated material, and a simulated distance from the user in the simulated environment.

15. The non-transitory computer-readable storage medium of claim 13, wherein the processed audio includes noise cancelling audio to cancel out reverberated audio from a physical environment in which the head-worn extended-reality device is placed.

16. A head-worn extended-reality device, comprising:
at least one microphone, at least one speaker, and audio processing components, wherein the audio processing components are configured to:
receive an audio input from the at least one microphone of the head-worn extended-reality device worn by a user, wherein the audio input is received while the user is at a location in a simulated environment;
process, via the audio processing components, the audio input into processed audio by changing the audio input based on simulated objects within the simulated environment, wherein the processed audio is configured to be perceived in a manner as if the audio input is being altered by the simulated environment;
transmit the processed audio to the head-worn extended-reality device for playback at the at least one speaker, such that the processed audio is perceived as being spoken in the simulated environment.

17. The head-worn extended-reality headset of claim 16, wherein the audio processing components are further configured to:
receive the audio input from the microphone at a head-worn extended-reality device worn by a user, wherein (i) the audio input is received while the user is at another location in the simulated environment and (ii) the audio input includes the representation of the user's voice;
process the audio input into another processed audio by changing the audio input based on the simulated objects within the simulated environment, wherein the processed audio is configured to be perceived by the user in a manner as if the audio input is being altered by the simulated environment; and
transmit the other processed audio to the head-worn extended-reality device for playback, such that the other processed audio is perceived as being spoken by the user in the simulated environment at the other location.

18. The head-worn extended-reality headset of claim 17, wherein the simulated environment includes a plurality of simulated objects that each have different acoustical properties, wherein the acoustical properties are defined by one or more of a simulated shape, a simulated material, and a simulated distance from the user in the simulated environment.

19. The head-worn extended-reality headset of claim 16, wherein the processed audio includes noise cancelling audio to cancel out reverberated audio from a physical environment in which the head-worn extended-reality device is placed.

20. The head-worn extended-reality device of claim 16, wherein processing the audio input includes producing a direct path impulse response (IR) and a reflected room impulse response (RIR) based on a directionality of an audio source at the location in the simulated environment.
